(19) United States
(12) Patent Application Publication
(10) Pub. No.: US 2007/0207643 A1
(43) Pub. Date: Sep. 6, 2007

(54) CONNECTOR

(75) Inventor: Yasuyoshi Yoshikai, Kanagawa (JP)

Correspondence Address: LOWE HAUPTMAN BERNER, LLP, 1700 DIAGONAL ROAD, SUITE 300, ALEXANDRIA, VA, 22314, US

(73) Assignee: IRISO ELECTRONICS CO., LTD., Kawasaki-shi, (JP)

(21) Appl. No.: 10/599,735

(22) PCT Filed: Jun. 30, 2005
(86) PCT No.: PCT/JP05/12089

§ 371 Date: Oct. 6, 2006

(30) Foreign Application Priority Data
Mar. 21, 2005 (JP) 2005-68443

(51) Int. Cl. H01R 13/648

(52) U.S. Cl. 439/108

(57) ABSTRACT

A connector prevents insertion of a pressing member into a connector body when an object to be connected is not fully inserted into the connector body. Each lock portion is a non-elastic member. The thickness of a pressing piece of a pressing member is gradually reduced toward its tip end with a gap between each of the lock portions and a fixed piece portion as the maximum. When a flexible cable is not fully inserted into the connector body, the pressing member can not be inserted into the rear of the connector body, and the flexible cable is not electrically connected in an incomplete insertion state. Therefore, disengagement of the flexible cable from the connector body or contact failure caused by displacement between the flexible cable and an elastic piece of each of the terminals can be surely prevented.

### TECHNICAL FIELD

The present invention relates to a connector for connecting an object to be connected such as a flexible print circuit board (FPC), flexible flat cable (FFC), etc., for example, to a circuit board.

### BACKGROUND ART

As this type of connector, such a connector is known that is provided with a connector body to which one end of an object to be connected can be inserted at a predetermined position, a plurality of terminals in contact with the object to be connected which was inserted into the connector body, and a pressing member for pressing the object to be connected which was inserted into the connector body on each of the terminals side and in which disengagement of the object to be connected from the connector body or occurrence of contact failure due to displacement is prevented by holding the object to be connected with the pressing member.

However, with this connector, as shown in FIGS. 8 and 9, even when an object to be connected B is not fully inserted into a connector body 1, a pressing member 3 can be inserted into the connector body 1 in some cases. In this case, since a contact area between the pressing member 3 and the object to be connected B inserted into the connector body 1 becomes small, a pressing force of the pressing member 3 against the object to be connected B is insufficient, and the object to be connected B might disengage from the connector body 1 or displacement between the object to be connected B and an elastic piece portion 2a of each of the terminals 2 might result in contact failure.

Then, such a connector is known in which an elastic support piece is provided on both ends in the terminal arranging direction of the connector body, and notch portions provided on both side ends of the object to be connected are fitted with the elastic support pieces and locked when the object to be connected is inserted into the connector body, so that movement of the object to be connected in the direction opposite to insertion is regulated (See the Patent Document 1, for example).

However, when the pressing member is inserted into the connector body in the state where the object to be connected is not fully inserted into the connected body, by pressing of the pressing member on the object to be connected, the elastic support piece is elastically deformed toward the terminal side together with the object to be connected. By this, the pressing member becomes capable of being inserted into the connector body even in the state where the object to be connected is not fully inserted into the connector body. Therefore, since the object to be connected is connected in the state where the pressing force of the pressing member against the object to be connected is not sufficient as mentioned above, disengagement of the object to be connected from the connector body or contact failure caused by displacement can not be prevented.

[Patent Document 1]: Japanese Patent Publication 2003-100370

The present invention was made in view of the above problems and has an object to provide a connector which prevents a pressing member from being inserted into a connector body when an object to be connected is not fully inserted into the connector body.

### DISCLOSURE OF THE INVENTION

The present invention is so constituted that, in a connector provided with a connector body to which one end of an object to be connected can be inserted at a predetermined position, a plurality of terminals in contact with the object to be connected inserted into the connector body and a pressing member for pressing the object to be connected to each of the terminals side, in which a lock portion is projected on both ends in the terminal arranging direction of the connector body and when the object to be connected is inserted into the connector body, notch portions provided on both side ends of the object to be connected are fitted with the lock portion and locked in the direction opposite to insertion, the lock portion is formed by a non-elastic member and insertion of the pressing member into the connector body is allowed in the state where the notch portions of the object to be connected which has been inserted into the connector body are fitted with the lock portion.

By this, when the object to be connected is fully inserted into the connector body, that is, when the notch portion of the object to be connected is fitted with the lock portion, the pressing member becomes capable of being inserted into the connector body. Also, when the object to be connected is not fully inserted into the connector body, that is, when the notch portion of the object to be connected is not fitted with the lock portion and the object to be connected goes onto the lock portion, the lock portion is not deformed toward the terminal side even if the pressing member is to be inserted and the pressing member can not be inserted into the connector body, since the lock portion is formed by a non-elastic member.

The above object and other objects, characteristics and advantages of the present invention will be made clear by the description below and attached drawings.

According to the present invention, when the object to be connected is not fully inserted into the connector body, the pressing member is not inserted into the connector body. Thus, the object to be connected is not connected to a circuit board in the state where the object to be connected is not fully inserted. Therefore, disengagement of the object to be connected from the connector body or contact failure caused by displacement between the object to be connected and each of the terminals can be surely prevented.

### BRIEFLY DESCRIBE OF THE DRAWINGS

FIG. 1 is a perspective view of a connector according to a preferred embodiment of the present invention;

FIG. 2 is a front view of a connector;

FIG. 3 is a plan view of a connector;

FIG. 4 is a plan view of a flexible cable;

FIG. 5 is a side sectional view showing operation of a connector;

FIG. 6 is a side sectional view showing operation of a connector;

FIG. 7 is a side sectional view showing operation of a connector;

FIG. 8 is a side sectional view showing operation of a conventional connector; and

FIG. 9 is a side sectional view showing operation of a conventional connector.

### DESCRIPTION OF SYMBOLS

10 . . . Connector body, 15 . . . Lock portion, 20 . . . Terminal, 30 . . . Pressing member, A . . . Flexible cable, A2 . . . Notch portion

### BEST MODE FOR CARRYING OUT THE INVENTION

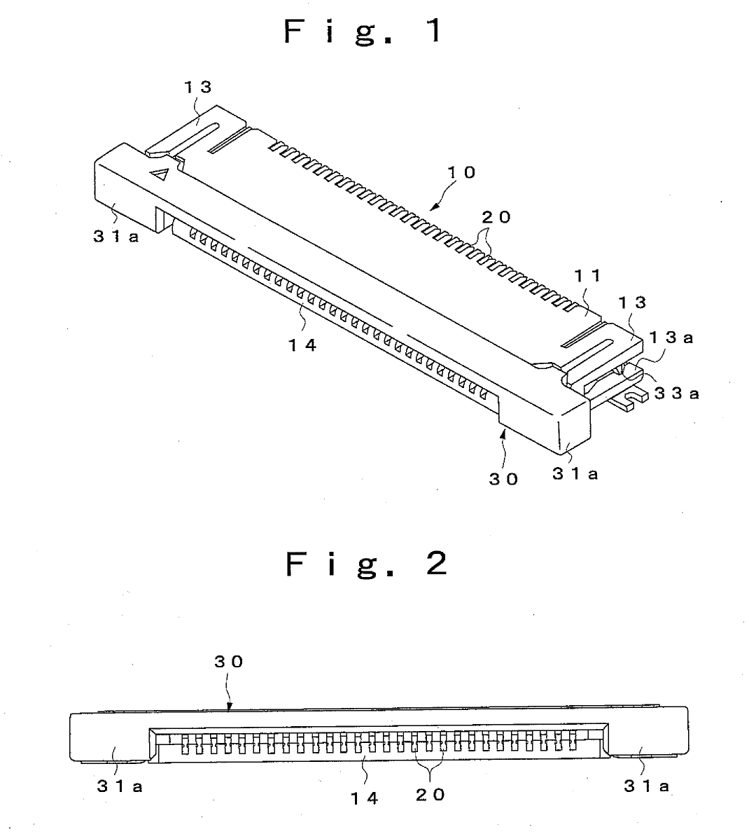

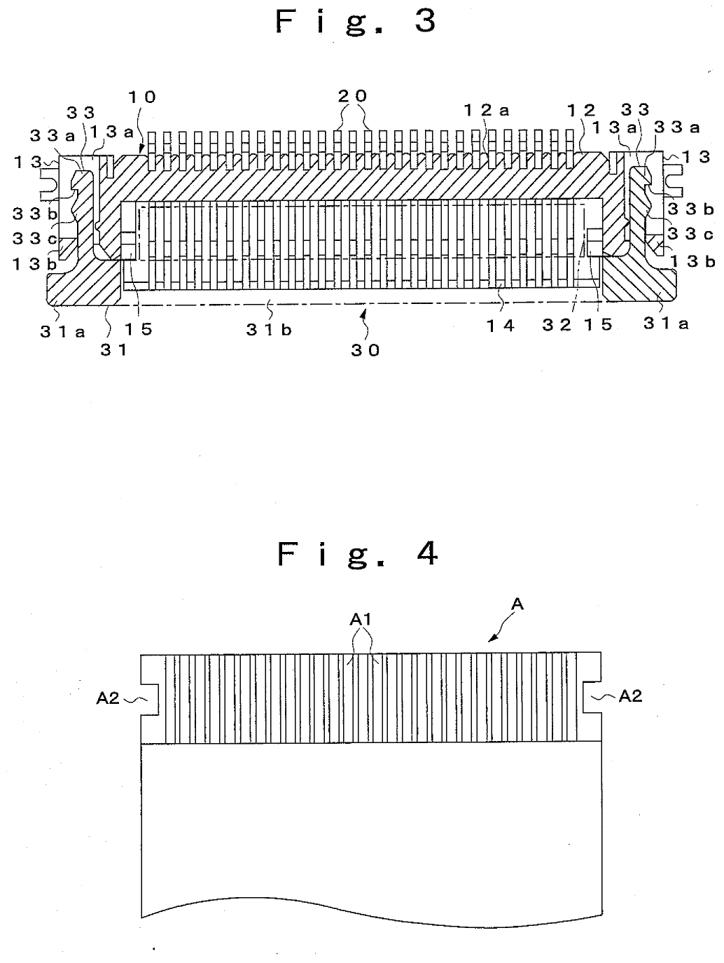

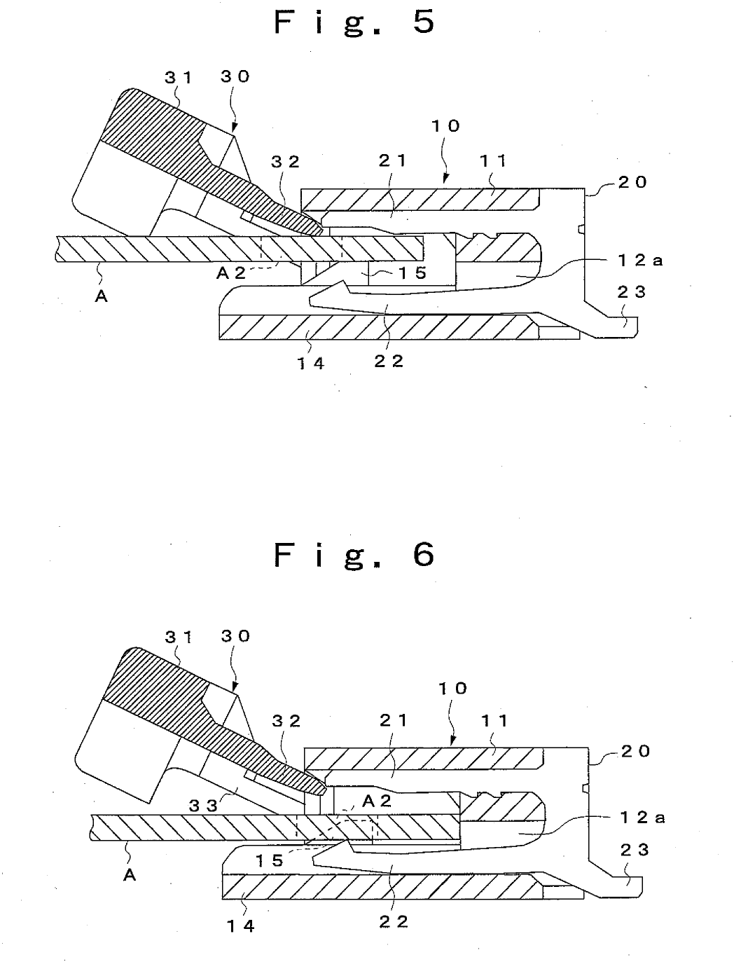

FIGS. 1 to 7 show a preferred embodiment of the present invention, in which FIG. 1 is a perspective view of a connector, FIG. 2 is a front view of a connector, FIG. 3 is a plan view of a connector, FIG. 4 is a plan view of a flexible cable, and FIGS. 5 to 7 are side sectional views showing operation of a connector.

This connector is constituted by a connector body 10 to which one end of a flexible cable A as an object to be connected can be inserted, a plurality of terminals 20 in electric contact with contacts of the flexible cable A inserted into the connector body 10, and a pressing member 30 for pressing the flexible cable A to each of the terminals 20 side.

The flexible cable A is what is called as flexible flat cable (FFC), in which a plurality of conductive portions A1 are provided on both an upper and a lower surfaces at its tip end with an interval to each other in the width direction. Also, at the both side ends of the flexible cable A are provided a pair of right and left notch portions A2. The object to be connected may be a flexible print circuit (FPC) or the like.

The connector body 10 is made of a molded product of a non-elastic material (synthetic resin, for example) and the front end side is formed in the opened box configuration. That is, the connector body 10 is constituted by an upper face portion 11, a back face portion 12, side face portions 13 and a bottom face portion 14, and the flexible cable A is inserted through its front face opening. On the back face portion 12, a plurality of terminal holes 12a are provided with an equal interval in the width direction, and each of the terminals 20 is respectively held in each of the terminal holes 12a. On each of the side face portions 13, an elongated hole 13a extending in the fore-and-aft direction, respectively, is provided so that the pressing member 30 is engaged with each of the elongated holes 13a and the pressing member 30 is locked by a front end portion 13b of each of the elongated holes 13a. On both ends of each of the terminal holes 12a in the arranging direction, a pair of right and left lock portions 15 integrally formed with the connector body 10 are projected upward. Each of the notch portions A2 of the flexible cable A is locked by each of the lock portions 15 in the direction opposite to insertion of the flexible cable A. Also, each of the lock portions 15 is formed higher than the height of each of the terminals 20 protruding in the direction in contact with the flexible cable A, that is, upward, and its front end is formed so that it makes an ascending inclination toward the rear of the connector body 10.

Each of the terminals 20 is made of a conductive metal plate and respectively held by each of the terminal holes 12a of the connector body 10. Each of the terminals 20 has a fixed piece portion 21 and an elastic piece portion 22 extending in the bifurcated state forward with an interval to each other in the vertical direction, and a board connection portion 23 to be connected to a board (not shown) is provided at its rear end.

The pressing member 30 is made of a molded product of a synthetic resin and is constituted by a manipulation portion 31 arranged outside the connector body 10, a pressing piece 32 arranged within the connector body 10 and a pair of right and left arm portions 33 to be inserted into the connector body 10. The manipulation portion 31 extends in the width direction of the pressing member 30 and a gripping portion 31a is projected on its both ends. Also, the manipulation portion 31 is provided with a recess portion 31b at the center on the lower face through which the flexible cable A can be inserted. The pressing piece 32 extends rearward from the center on the back face of the manipulation portion 31 and is located below the fixed piece portion 21 of each of the terminals 20. Also, the thickness dimension of the pressing piece 32 is formed so that it becomes gradually smaller toward the tip end with the gap between each of the lock portions 15 and the fixed piece portion 21 as the maximum. Each of the arm portions 33 extends rearward from the both ends on the back face of the manipulation portion 31 and is inserted into each of the elongated holes 13a of the connector body 10, respectively, capable of movement in the fore-and-aft direction. Also, a lock piece 33a to be locked by the front end portion 13b of the elongated hole 13a is provided at the tip end of each of the arm portions 33 so that it protrudes in the width direction, and the front face of the lock piece 33a, that is, the face locked by the front end portion 13b of each of the elongated holes 13a is formed by an inclined surface 33b forming a rearward descending inclination. Also, at the center in the fore-and-aft direction of each of the arm portions 33 is provided an angular projection portion 33c projecting in the width direction, and when the arm portion 33 is moved in the fore-and-aft direction, the projection portion 33c forcibly overrides the front end portion 13b of the elongated hole 13a by elastic deformation of the arm portion 33.

In the connector constituted as above, by soldering the board connection portion 23 of each of the terminals 20 to a board, each of the terminals 20 is connected to the board. Also, when the flexible cable A is to be connected to the connector, by withdrawing the pressing member 30 forward as shown in FIG. 5, the flexible cable A becomes capable of being inserted into the connector body 10. That is, the thickness dimension of the pressing piece 32 of the pressing member 30 is formed so that it is gradually reduced toward the tip end side with the gap between each of the lock portions 15 and the fixed piece portion 21 as the maximum, and when the pressing member 30 is moved forward, a gap between each of the lock portions 15 and the pressing piece 32 is widened, and the flexible cable A becomes capable of being inserted between each of the lock portions 15 and the pressing piece 32. Also, when the pressing member 30 is withdrawn forward, the projection portion 33c of each of the arm portions 33 overrides the front end portion 13b of the elongated hole 13a and the lock piece 33a of the arm portion 33 is locked by the front end portion 13b of the elongated hole 13a, by which the pressing member 30 is held at the withdrawn position. At that time, the inclined surface 33b of the lock piece 33a is brought into contact with the front end portion 13b of the elongated hole 13a, and the inclined surface 33b tends to be perpendicular along the front end portion 13b of the elongated hole 13a by the holding force by the projection portion 33c to the front position of the pressing member 30. By this, as shown in FIG. 5, the pressing member 30 is moved rotationally upward and its front end side is raised, by which insertion of the flexible cable A is facilitated.

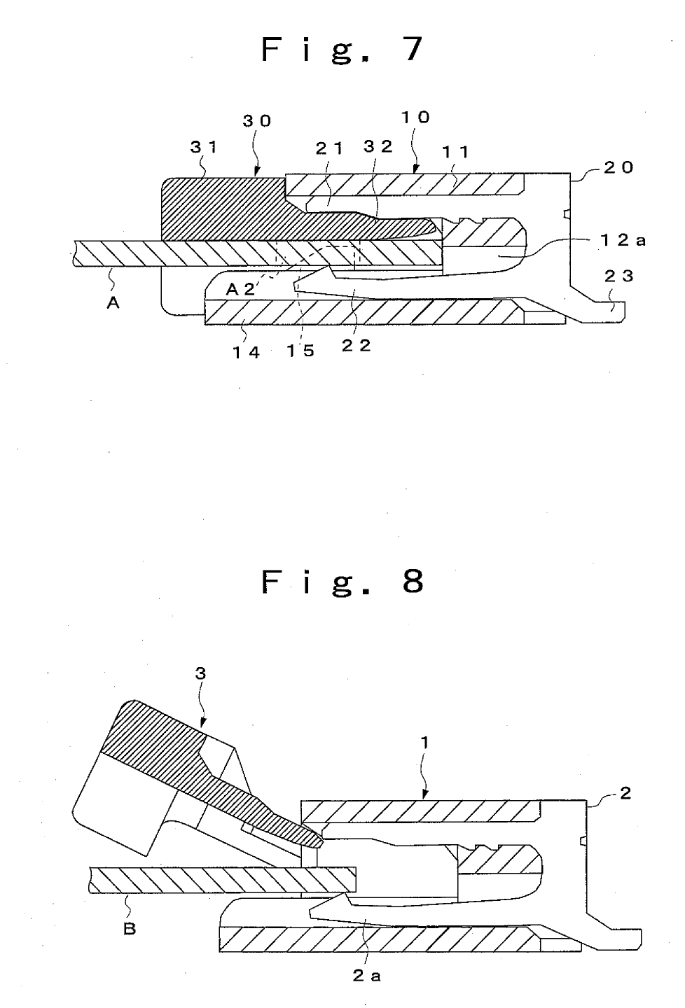

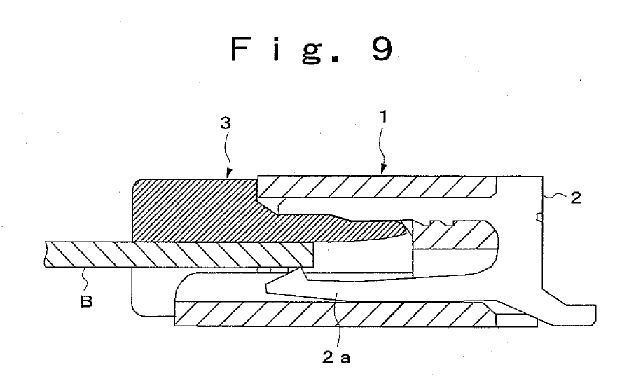

Next, when the flexible cable A is inserted into the connector body 10, both ends in the width direction at the tip end of the flexible cable A are brought into contact with the front end of each of the lock portions 15 and then, goes onto the upper face of each of the lock portion 15 while being guided by the inclined surface on the front end side of each of the lock portions 15. And as shown in FIG. 6, when the flexible cable A is further inserted toward the rear of the connector body 10, each of the notch portions A2 of the flexible cable A and each of the lock portions 15 of the connector body 10 are fitted with each other and the flexible cable A is moved downward. Then, each of conductive portions A1 of the flexible cable A comes into contact with the elastic portion 22 of each of the terminals 20, and each of the notch portions A2 of the flexible cable A is locked by each of the lock portions 15. By this, the flexible cable A is fully inserted into the connector body 10. At this time, since the flexible cable A does not exist between the upper face of each of the lock portions 15 and the fixed piece portion 21, when the pressing piece 32 of the pressing member 30 is inserted toward the rear of the connector body 10, the gap between the pressing piece 32 and the elastic piece portion 22 is gradually narrowed through the flexible cable A, and the flexible A is pressed onto the elastic piece portion 22 side by the pressing piece 32. And as shown in FIG. 7, the pressing member 30 is inserted into the connector body 10 and the flexible cable A and the elastic piece portion 22 of each of the terminals 20 are brought into pressure contact with each other and electrically connected.

Also, in the state where the flexible cable A is not fully inserted, that is, the flexible cable A is not inserted to the position where each of the notch portions A2 of the flexible cable A is fitted with each of the lock portions 15 and the flexible cable A goes on to each of the lock portions 15, when the pressing member 30 is to be inserted toward the rear of the connector body 10 while being rotated downward, since the thickness dimension of the pressing piece 32 is larger than the gap between the flexible cable A which has gone on to the upper face of each of the lock portions 15 and the fixed piece portion 21 of each of the terminals 20, the pressing member 30 can not be inserted to the rear of the connector body 10. At that time, even if the flexible cable A is pressed downward by the pressing member 30, each of the lock portions 15 made of a non-elastic member is not deformed, and a gap through which the pressing member 30 is inserted can not be formed. In this way, according to the connector of this preferred embodiment, since each of the lock portions 15 is made of a non-elastic member and the thickness dimension of the pressing piece 32 of the pressing member 30 is formed so that it is gradually narrowed toward the tip end with the gap between each of the lock portions 15 and the fixed piece portion 21 as the maximum, when the flexible cable A is fully inserted into the connector body 10, that is, when each of the notch portions A2 of the flexible cable A is fitted with each of the lock portions 15, the pressing member 30 can be inserted into the connector body 10. When the flexible cable A is not fully inserted into the connector body 10, that is, when each of the notch portions A2 is not fitted with each of the lock portions 15 and the flexible cable A goes on to each of the lock portions 15, the pressing member 30 can not be inserted to the rear of the connector body 10, and the flexible cable A is not connected in the incomplete inserted state. Therefore, disengagement of the flexible cable A from the connector body 10 or contact failure caused by displacement between the flexible cable A and the elastic piece portion 22 of each of the terminals 20 can be surely prevented.

Moreover, since each of the lock portions 15 is formed integrally with the connector body 10, contact with the flexible cable A resulting in displacement of each of the lock portions 15 and non-fitting between the notch portion A2 of the flexible cable A and each of the lock portions 15 can be prevented, and when the flexible cable A is fully inserted, each of the notch portions A2 of the flexible cable A can be surely fitted with each of the lock portions 15 and the flexible cable A can be pressed by the pressing member 30.

Moreover, since the front end of each of the lock portions 15 is formed so that it is upwardly inclined toward the rear of the connector body 10, when the both ends in the width direction of the tip end of the flexible cable A are brought into contact with the front end of each of the lock portions 15, the flexible cable A can be easily inserted to the rear of the connector body 10 by going on to the upper face of each of the lock portions 15 while being guided by the inclined surface of the front end of each of the lock portions 15. Therefore, advantageously, when the flexible cable A is inserted into the connector body 10, insertion is not prevented by contact between the tip end of the flexible cable A and the front end of each of the lock portions 15.

Moreover, since each of the lock portions 15 is formed so that it is higher than the height of each of the terminals 20 in the direction in contact with the flexible cable A, that is, protruding upward, when the flexible cable A is inserted into the connector body 10, each of the conductive portions A1 of the flexible cable A is not brought into contact with each of the terminals 20. Therefore, damage such as streaks on each of the conductive portions A1 of the flexible cable A due to contact with each of the terminals 20 can be surely prevented.

In the above preferred embodiment, an example in which each of the lock portions 15 is formed integrally with the connector body 10 is shown, but a lock portion made of a non-elastic member different from the connector body 10 may be provided on the connector body 10.

1. A connector provided with a connector body to which one end of an object to be connected can be inserted at a predetermined position, a plurality of terminals in contact with the object to be connected inserted into the connector body, and a pressing member for pressing the object to be connected which has been inserted into the connector body to each of the terminals side, in which a lock portion is projected on both ends in the terminal arranging direction of the connector body, and when the object to be connected is inserted into the connector body, a notch portion provided on both side ends of the object to be connected is fitted with the lock portion and locked in the direction opposite to insertion,
said lock portion is formed by a non-elastic member and
insertion of the pressing member into the connector body is allowed in the state where the notch portion of the object to be connected which has been inserted into said connector body is fitted with the lock portion.

2. The connector according to claim 1, wherein said lock portion is formed integrally with the connector body.

3. The connector according to claim 1, wherein a front end of said lock portion is formed so that it is upwardly inclined toward the rear of the connector body.

4. The connector according to claim 1, wherein said lock portion is formed higher than the height of each of the terminals protruding in the direction in contact with the object to be connected.

5. The connector according to claim 2, wherein a front end of said lock portion is formed so that it is upwardly inclined toward the rear of the connector body.

6. The connector according to claim 2, wherein said lock portion is formed higher than the height of each of the terminals protruding in the direction in contact with the object to be connected.

7. The connector according to claim 3, wherein said lock portion is formed higher than the height of each of the terminals protruding in the direction in contact with the object to be connected
